(19) United States
(12) Patent Application Publication
(10) Pub. No.: US 2025/0161159 A1
(43) Pub. Date: May 22, 2025

(54) Multi-Dimensional Feature Acquisition Device for Acquiring the Features of Shallow-Needle Acupuncture Techniques

(71) Applicant: Zhongshu (Fujian) Medical Technology, Inc., Fuzhou (CN)

(72) Inventors: Jianping He, Fuzhou (CN); Feng Wang, Fuzhou (CN)

(73) Assignee: Zhongshu (Fujian) Medical Technology, Inc., Fuzhou (CN)

(21) Appl. No.: 18/943,052

(22) Filed: Nov. 11, 2024

(30) Foreign Application Priority Data
Nov. 16, 2023 (CN) 202323102589X

(51) Int. Cl. A61H 39/08; A61H 23/02

(52) U.S. Cl. CPC A61H 39/086; A61H 23/02; A61H 2201/5005; A61H 2201/5015; A61H 2201/503; A61H 2201/5084

(57) ABSTRACT

The invention discloses a multi-dimensional feature acquisition device for acquiring the features of shallow-needle acupuncture techniques. The multi-dimensional feature acquisition device includes a pressing pressure signal acquisition module and a data processing module. The pressing pressure signal acquisition module is used for acquiring pressing pressure signals during the shallow-needle acupuncture. The data processing module is electrically connected to the pressing pressure signal acquisition module to receive, analyze and process the pressing pressure signals, and obtain pressing-pressure parameters, thereby providing reference pressing pressure parameters for the shallow acupuncture instrument. The shallow acupuncture instrument does not enter the vibration working mode when the pressing pressure value is not within the required range. Only when the pressing pressure value falls in the required range, the shallow acupuncture instrument can enter the vibration working mode, hence to ensure the effectiveness of shallow acupuncture operation.

### CROSS-REFERENCE TO RELATED APPLICATION

This application claims priority of Chinese application No. 202323102589.X filed on Nov. 16, 2023.

### TECHNICAL FIELD

The invention relates to the technical field of a multi-dimensional feature acquisition device, in particular relates to a multi-dimensional feature acquisition device for acquiring the features of shallow-needle acupuncture techniques.

### BACKGROUND

Nowadays, many TCM practitioners use shallow needles to treat patients, the working principle is that by scraping the helix coil on the external surface of the shallow needle, the shallow needle generates vibration waves of a certain frequency, which can treat the patients. However, the shallow-needle acupuncture techniques are usually taught in master-apprentice manner wherein the master demonstrates and the apprentice watches and then practices on experiencers. Those experiencers judge the proficiency of the apprentice based on their own feelings which are subjective. This makes it difficult to reproduce the acupuncture techniques of masters, and the effectiveness of shallow acupuncture operation is hard to guarantee.

To solve this problem, a feature acquisition device is designed and includes an acceleration sensor, an MCU and a storage module. The acceleration sensor is bonded to the shallow needle. The helix coil on the shallow needle is scraped to cause the shallow needle to vibrate. The acceleration sensor acquires the three-axis acceleration values of the vibration waves when the shallow needle is scraped, and transmits the acceleration data to the MCU for categorization and storage. The MCU will transmit the acquired acceleration value through the USB data interface to an external PC, where waveforms will be analyzed and processed to obtain vibration parameters. The vibration parameters are downloaded into the shallow acupuncture instrument. When the shallow acupuncture instrument works, its vibrating head can produce corresponding vibration according to the vibration parameters.

However, during the process of shallow-needle acupuncture, appropriate pressing pressure is also necessary to be exerted on the acupuncture recipient to ensure the effectiveness of shallow acupuncture operation. The parameters acquired by the above feature acquisition device are only vibration parameters formed by scraping the shallow needle, which is not sufficient to ensure the effectiveness of the operation of the shallow acupuncture instrument.

In view of the aforementioned insufficiency, it is necessary to design a multi-dimensional feature acquisition device for acquiring the features of shallow-needle acupuncture techniques.

### SUMMARY

Therefore, the technical problem to be solved by the invention is that the acquisition device in previous methods only acquires vibration parameters, which are not sufficient to ensure the effectiveness of operation of the shallow acupuncture instrument. Accordingly, the invention provides a multi-dimensional feature acquisition device for acquiring the features of shallow-needle acupuncture techniques.

In order to solve the above technical issue, the technical solution of the invention is as follows:

A multi-dimensional feature acquisition device for acquiring the features of shallow-needle acupuncture techniques includes a pressing-pressure signal acquisition module and a data processing module; the pressing-pressure signal acquisition module is used for acquiring pressing-pressure signals during the shallow-needle acupuncture, and the data processing module is electrically connected to the pressing-pressure signal acquisition module to receive, analyze and process pressing-pressure signals to obtain the pressing-pressure parameters.

Further, the pressing-pressure signal acquisition module includes a push-pull force gauge, and one end of the shallow needle is in contact with the push-pull force gauge and the other end is pressed by acupuncturists.

Further, the push-pull force gauge has a range of 10 g to 200 g.

Further, the multi-dimensional feature acquisition device for acquiring shallow-needle acupuncture techniques includes a vibration signal acquisition module and a data processing module; the vibration signal acquisition module is used for acquiring vibration signals during the shallow-needle acupuncture, and the data processing module is electrically connected to the vibration signal acquisition module to receive, analyze and process vibration signals to obtain the vibration parameters.

Further, the vibration signal acquisition module includes an acceleration sensor which is connected to the data processing module.

Further, the acceleration sensor is connected to the data processing module via a USB interface board.

Further, the acceleration sensor is bonded to one side of the shallow needle.

Further, the lengthwise direction of the shallow needle is perpendicular to the plane on which the X-axis and Y-axis of the acceleration sensor are located.

Further, the acceleration sensor is bonded to the shallow needle.

Further, the data processing module analyzes and processes the vibration signals and generates the original vibration time-domain waveforms of shallow-needle acupuncture techniques and/or the synthesized vibration time-domain waveforms of simulating shallow-needle acupuncture techniques.

The technical solution of the invention has the following advantages:
1. The invention provides a multi-dimensional feature acquisition device for acquiring the features of shallow-needle acupuncture techniques, which includes a pressing-pressure signal acquisition module and a data processing module. The pressing-pressure signal acquisition module is used for acquiring pressing-pressure signals during the shallow-needle acupuncture. The data processing module is electrically connected to the pressing-pressure signal acquisition module to receive, analyze and process the pressing-pressure signals, and obtain pressing-pressure parameters, thereby providing reference pressing-pressure parameters for the shallow acupuncture instrument. The shallow acupuncture instrument does not enter the vibration working mode when the pressing-pressure value is not within the required range, and the shallow acupuncture instrument enters the vibration working mode only when the pressing pressure value falls in the required range, in order to ensure the effectiveness of shallow acupuncture operation.
2. The multi-dimensional feature acquisition device for acquiring the features of shallow-needle acupuncture techniques uses a push-pull force gauge to acquire the pressing-pressure signals, which is simple and convenient.
3. The multi-dimensional feature acquisition device for acquiring the features of shallow-needle acupuncture techniques further includes a vibration signal acquisition module which is used for acquiring vibration signals generated by scraping the helix coil on the shallow needle; and the data processing module is electrically connected to the vibration signal acquisition module to receive, analyze and process vibration signals, and obtains vibration parameters. In this way, vibration parameters together with pressing-pressure parameters, can provide a more comprehensive parameter basis for the shallow acupuncture instrument, thereby ensuring the effectiveness of shallow acupuncture operation.
4. In the multi-dimensional feature acquisition device for acquiring the features of shallow-needle acupuncture techniques provided by the invention, the acceleration sensor is bonded to one side of the shallow needle, and the lengthwise direction of the shallow needle is perpendicular to the plane where the X-axis and Y-axis of the acceleration sensor are located, so that the acceleration sensor can monitor the vibration signals in lengthwise direction where the vibration sensation of the shallow needle is the strongest.
5. In the multi-dimensional feature acquisition device for acquiring the features of shallow-needle acupuncture techniques provided by the invention, the acceleration sensor is bonded to the shallow needle, so that the vibration conduction can be more direct.
6. In the multi-dimensional feature acquisition device for acquiring the features of shallow-needle acupuncture techniques provided by the invention, the data processing module analyzes and processes the vibration signals and generates the original vibration time-domain waveforms of shallow-needle acupuncture techniques and the synthesized vibration time-domain waveforms of simulating shallow-needle acupuncture techniques. In this way, the shallow acupuncture instrument can have two vibration modes, thereby providing more functional choices of the shallow acupuncture instrument.

### BRIEF DESCRIPTION OF THE DIAGRAMS

To provide a clearer illustration of specific embodiments of the invention or technical solutions in the prior art, a brief description of the diagrams required to describe specific embodiments or the prior art will be given below. Apparently, the diagrams described below are some embodiments of the invention, based on which other diagrams can be acquired by those of ordinary skill in the art without any inventive efforts.

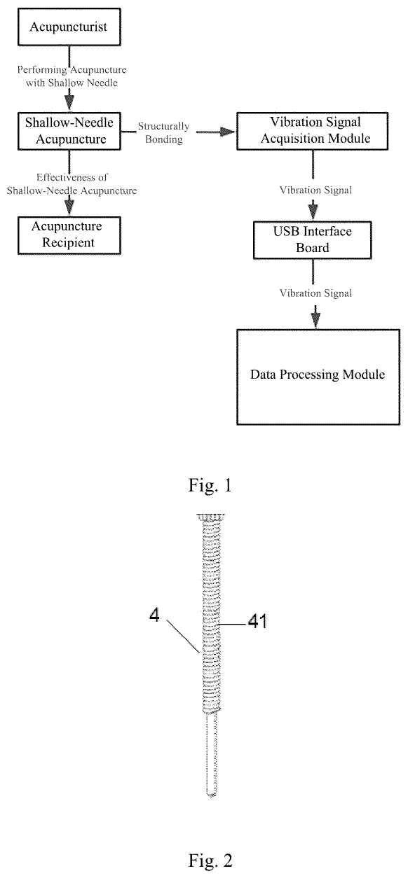

FIG. 1 is the flow chart of obtaining vibration parameters;

FIG. 2 is the structural schematic diagram of the shallow needle;

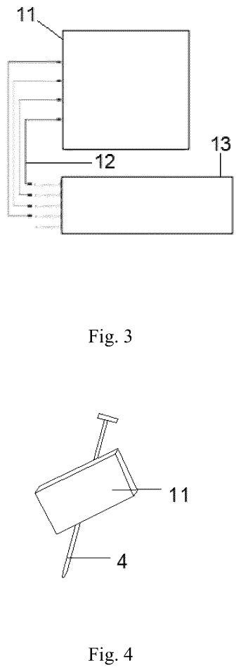

FIG. 3 is the structural schematic diagram of the vibration signal acquisition module;

FIG. 4 is schematic diagram of the bonding of the vibration signal acquisition module and the shallow needle;

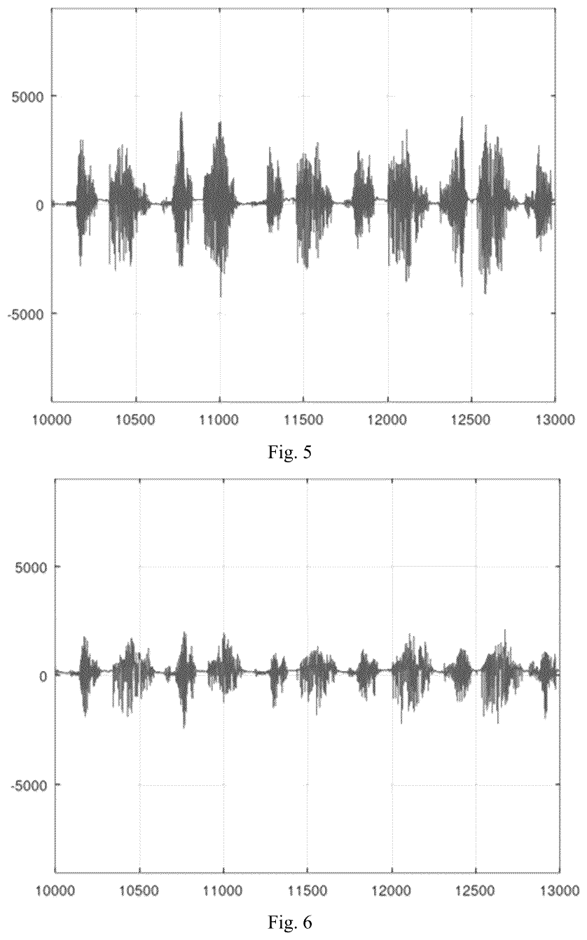

FIG. 5 is the time-domain waveform of X-axis vibration drawn by the data processing module based on vibration signals;

FIG. 6 is the time-domain waveform of Y-axis vibration drawn by the data processing module based on vibration signals;

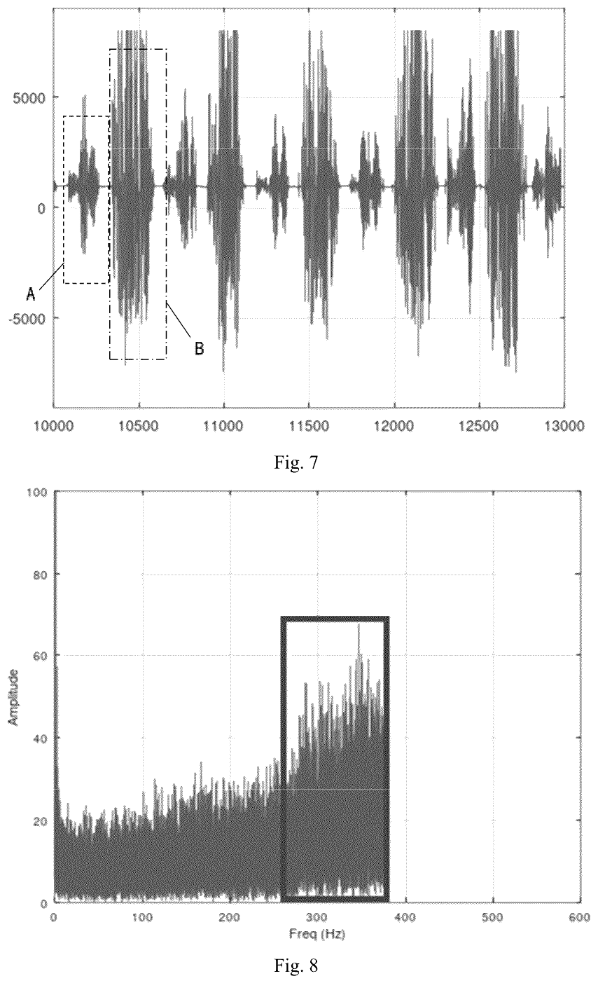

FIG. 7 is the time-domain waveform of Z-axis vibration drawn by the data processing module based on vibration signals;

FIG. 8 is the spectrum of Z-axis vibration drawn by the data processing module based on vibration signals;

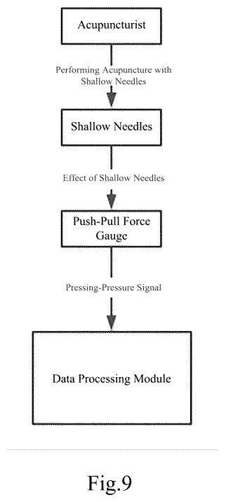

FIG. 9 is the flow chart of obtaining pressing-pressure parameters;

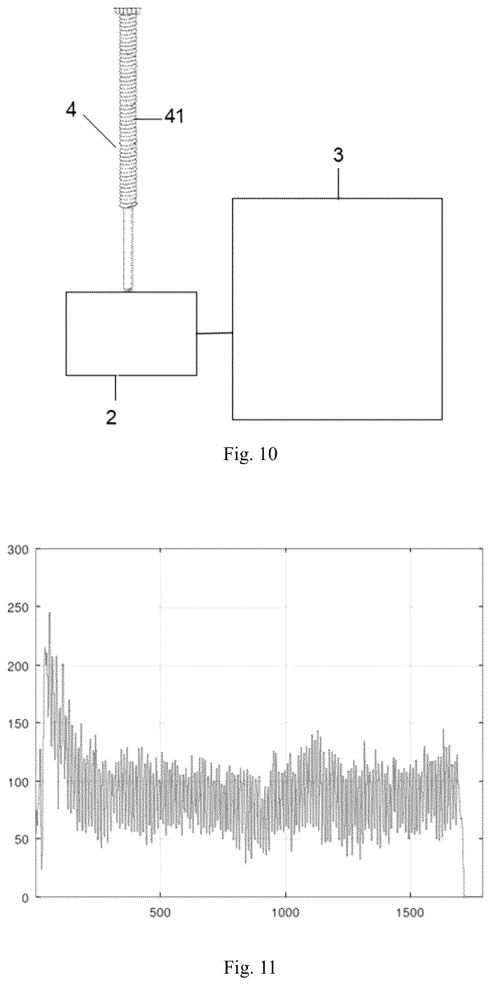

FIG. 10 is the schematic diagram of the connection of the shallow needle, the pressing-pressure signal acquisition module and the data processing module;

FIG. 11 is the pressing-pressure waveform drawn by the data processing module based on pressing-pressure signals;

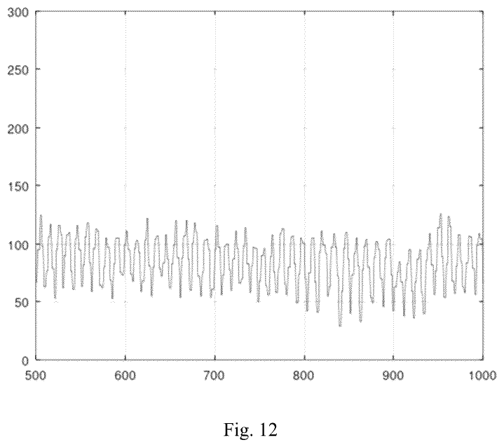

FIG. 12 is a part of pressing-pressure waveforms extracted from FIG. 11.

### REFERENCE SIGNS ON DRAWINGS

1. vibration signal acquisition module; 11. acceleration sensor; 12. wire; 13. USB interface board; 2. pressing-pressure signal acquisition module; 3. data processing module; 4. shallow needle; 41. helix coil.

### DETAILED DESCRIPTION OF PREFERRED EMBODIMENTS

A clear and complete description of the technical solutions in the invention will be given below in combination with the drawings. Apparently, the embodiments described below are some but not all of the embodiments of the invention. All of the other embodiments, obtained by ordinary technical personnel in the field, on the basis of the embodiments of the invention without inventive efforts, are within the protection scope of the invention.

In the description of the invention, it should be noted that the terms “center”, “top”, “bottom”, “left”, “right”, “vertical”, “horizontal”, “inside”, “outside” and the like indicate directional or positional relationships based on those shown in the diagrams. These terms which are only intended to facilitate and simplify the description of the invention, do not indicate or imply that the device or element referred must have a particular orientation, or be constructed and operated in a particular orientation, and therefore shall not be construed as a limitation of the invention. In addition, the terms “first”, “second”, “third” are used for descriptive purposes only and are not to be understood as indicating or implying relative importance.

In the description of the invention, it should be noted that, unless otherwise expressly specified and limited, the terms “mounted”, “bonded” and “connected” are to be broadly construed and may, for example, be construed as fixedly connected, detachably connected, integrally connected, mechanically or electrically connected, directly connected, indirectly connected through intermediate media, or internally connected between two components. The specific meaning of the above terms in the invention can be understood according to specific situations by those of ordinary skill in the art.

Furthermore, the technical features involved in the different embodiments of the invention described below can be combined as long as they do not conflict with each other.

As shown in FIG. 1 to 12, the embodiment provides a multi-dimensional feature acquisition device for shallow-needle acupuncture techniques, which includes vibration signal acquisition module 1, pressing-pressure signal acquisition module 2, and data processing module 3. The multi-dimensional feature acquisition device is used to acquire vibration parameters and pressing-pressure parameters generated by shallow-needle acupuncture for the design of the shallow acupuncture instrument.

The vibration signal acquisition module 1 is used to acquire vibration signals generated when the helix coil 41 on the shallow needle 4 is scraped. (the shallow needle 4 is a manually operated acupuncture needle by itself alone, which is different from the shallow acupuncture instrument). The shallow needle 4 is shown in FIG. 2.

The data processing module 3 is electrically connected to the vibration signal acquisition module 1, to receive, analyze and process the vibration signals to obtain vibration parameters. In this embodiment, the vibration signal acquisition module 1 includes acceleration sensor 11 and wire 12. The acceleration sensor 11 is bonded to one side of the shallow needle 4, and, the lengthwise direction of the shallow needle 4 is perpendicular to the plane on which the X-axis and the Y-axis of the acceleration sensor are located, so that the acceleration sensor 11 can monitor the vibration signal of the shallow needle 4 in the lengthwise direction in which the vibration sensation of the shallow needle 4 is the strongest. Particularly, the acceleration sensor 11 is bonded to the shallow needle 4, so that the vibration conduction can be more direct. One end of the wire 12 is connected to the acceleration sensor 11, and the other end is connected to the data processing module 3 (in this embodiment, the data processing module 3 is a computer) via the USB interface board 13. The acceleration sensor 11 is a mature commercial product, its structure will not be elaborated here.

During acquisition, the shallow needle 4 is bonded on one side of the acceleration sensor 11, and the helix coil 41 on the shall needle 4 is scraped to cause the shallow needle 4 to vibrate. Using the software kit of the acceleration sensor ADXL355 to acquire and record the vibration acceleration values on three axes. For data acquisition in this embodiment, a baud rate of 115,200, and a data transfer rate of 1,000 Hz in this embodiment) are selected, resulting in an actual data sampling rate of 750 Hz. A corresponding software program is written on a computer with scientific computing software Octave to analyze the vibration signals of the shallow needle to obtain vibration parameters (in this embodiment, the vibration signal is the acceleration values acquired by the acceleration sensor on three axes). The vibration parameters can be presented in the form of vibration time-domain waveform and vibration spectrum on a computer. The vibration parameters are stored in a storage unit of a computer or, transferred by wire to the shallow acupuncture instrument. The generated vibration time-domain waveform includes the original vibration time-domain waveform of shallow-needle acupuncture techniques and the synthesized vibration time-domain waveform simulating shallow-needle acupuncture techniques. Therefore, the shallow acupuncture instrument has two vibration modes to choose. The vibration time-domain waveform of the shallow acupuncture instrument is PCM waveform sequence data that are generated from replicating the acupuncture techniques of acupuncturists.

FIGS. 5 to 7 are vibration time-domain waveforms corresponding to X, Y, Z axes with the reinforcing or reducing acupuncture method, respectively. As shown in these figures, Wave A in the first amplitude range (shown in FIG. 7) and Wave B in the second amplitude range (shown in FIG. 7) alternatively present on all three axes (namely X, Y, and Z axes), with the most significant effect on Z axis. Wave A in the first amplitude range and Wave B in the second amplitude range, occupy a total time duration of 450 ms to 550 ms (500 ms in this embodiment). A time duration of 450 ms to 550 ms corresponds to one complete scraping operation cycle of the shallow needle 4. The feature acquisition of the even reinforcing-reducing acupuncture method is in the same way as that for reinforcing and reducing acupuncture methods, which will not be elaborated here.

In combination with the analysis of shallow-needle acupuncture technique described in monograph “Wu's Shallow Acupuncture”, the amplitude of the acquired vibration time-domain waveforms of shallow-needle acupuncture technique, corresponds to the scraping strength of shallow-needle acupuncture techniques.

The waveform of the reinforcing acupuncture method, corresponds to the acupuncture technique of lightly upward scraping and heavily downward scraping, featuring the vibration waveform amplitude of upward scraping in the first half (as Wave A in the first amplitude range shown in FIG. 7) is lower than that of the downward scraping in the second half (as Wave B in the second amplitude range shown in FIG. 7).

The waveform of the reducing acupuncture method, corresponds to the acupuncture technique of heavily upward scraping and lightly downward scraping, featuring the vibration waveform amplitude of upward scraping in the first half (as Wave B in the first amplitude range shown in FIG. 7) is greater than that of the downward scraping in the second half (as Wave A in the second amplitude range shown in FIG. 7).

The waveform of the even reinforcing-reducing acupuncture method, corresponds to the acupuncture technique of evenly upward and downward scraping, featuring the vibration waveform amplitude of upward scraping in the first half basically equals to that of downward scraping in the second half, which is not illustrated by figure in this embodiment.

FIG. 8 is a vibration spectrum drawn by the data processing module 3 based on the vibration parameters. It can be seen from the spectrum, the main peak section is presented in the frequency range of 200 Hz to 300 Hz, which is also consistent with the actual vibration situation of the shallow needle 4. One direction scraping acupuncture operation touches about 60 turns of helix coil, one upward-downward-scraping acupuncture cycle touches about 120 turns of helix coil, thereby generating 120 times of tiny vibrations. and one upward-downward-scraping acupuncture cycle is about 500 ms. Therefore, the frequency of the tiny vibrations generated by scraping the shallow needle 4 is about 120 vibrations/0.5 seconds, i.e., 240 Hz.

As shown in FIGS. 9 and 10, the pressing-pressure signal acquisition module 2 is used to acquire pressure signals of pressing shallow needle 4. The data processing module 3 is electrically connected to the pressing-pressure signal acquisition module 2 to receive, analyze and process the pressing pressure signals, and obtain pressure parameters. Specifically, the press-pressure signal acquisition module 2 includes a push-pull force gauge and wire. The push-pull force gauge is connected to the data processing module 3 via the wire, and the range of the push-pull force gauge is from 10 g to 200 g.

During acquisition, the acupuncturat presses the bottom of the shallow needle 4, the tip of the shallow needle 4 is vertically pressed on the push-pull force gauge. The force gauge acquires 1,700 pressing-pressure data for about 170 seconds, and generates 1,700 pressing-pressure signals which are transmitted to the data processing module 3 through the wire. From these 1,700 pressing-pressure signals, 500 stable signals (with a duration of about 50 seconds, 45 fluctuation cycles, and an average cycle of 1.1 seconds) are selected and analyzed by the data processing module 3 to obtain the pressing-pressure parameters. The press-pressure signals are analyzed and the following results are obtained: the average press-pressure is 84 g, with the maximum value of 126 g, and the minimum value of 29 g. Four expert doctors in the rehabilitation department of Fujian Provincial Rehabilitation Hospital participated in the shallow needle pressing-pressure data acquisition. Each one of the doctors used three shallow-needle acupuncture techniques (reinforcing, reducing and even reinforcing-attenuating, respectively), a total of 12 groups of pressing-pressure data of the shallow needle 4 are acquired, and the pressing-pressure range is determined from 53 g to 152 g, in order to avoid too small pressing pressure that affects the effectiveness of shallow acupuncture operation.

It should be noted that the pressing-pressure signals acquired by the push-pull force gauge are a press force formed by the superposition of three factors: the first factor is a relatively constant pressure generated by acupuncturists by pressing on the bottom of the shallow needle 4; the second factor is a pressure fluctuation of about 1 Hz with the movement of scraping shallow needle 4; and the third factor is a vibration wave of about 200 Hz by scraping the helix coil on the shallow needle 4. That is to say, the pressing-pressure is not constant. Therefore, the pressing pressure waveforms plotted based on the pressing-pressure parameters as shown in FIGS. 11 and 12 are not a straight lines but curved ones.

In this embodiment of the multi-dimensional feature acquisition device for shallow-needle acupuncture techniques, due to the presence of pressing-pressure signal acquisition module, pressing-pressure parameters can be provided as a reference for the shallow acupuncture instrument. The shallow acupuncture instrument does not enter the vibration working mode when the pressing pressure value is not within the required range of the pressing-pressure parameters, and the shallow acupuncture instrument can enter the vibration working mode only when the pressing pressure value falls in the required range, to ensure that the appropriate pressure is applied to the acupuncture recipient, thereby ensuring the effectiveness of shallow acupuncture operation. The pressing-pressure parameter is provided together with vibration parameters to make the shallow acupuncture instrument more effective.

Obviously, the above embodiments are merely examples for clear illustration and do not limit the embodiments of the invention. Other modifications or variations in different forms may be made by those of ordinary skill in the art on the basis of the foregoing descriptions. It is neither necessary nor possible to exhaustively enumerate all embodiments herein. Obvious modifications or variations derived herefrom are still within the scope of protection of the invention.

What is claimed is:

1. A multi-dimensional feature acquisition device for acquiring the features of shallow-needle acupuncture techniques, wherein the multi-dimensional feature acquisition device includes a pressing-pressure signal acquisition module and a data processing module; the pressing-pressure signal acquisition module is used for acquiring pressing-pressure signals during the shallow-needle acupuncture, and the data processing module is electrically connected to the pressing-pressure signal acquisition module to receive, analyze and process pressing-pressure signals and obtain pressing-pressure parameters.

2. The multi-dimensional feature acquisition device for acquiring the features of shallow-needle acupuncture techniques according to claim 1, wherein the pressing-pressure signal acquisition module includes a push-pull force gauge, and one end of the shallow needle is in contact with the push-pull force gauge and the other end is pressed by acupuncturists.

3. The multi-dimensional feature acquisition device for acquiring the features of shallow-needle acupuncture techniques according to claim 2, wherein the push-pull force gauge has a range of 10 g to 200 g.

4. The multi-dimensional feature acquisition device for acquiring the features of shallow-needle acupuncture techniques according to claim 1, wherein the multi-dimensional feature acquisition device further includes a vibration signal acquisition module which is used for acquiring vibration signals generated by scraping the helix coil on the shallow needle; and the data processing module is electrically connected to the vibration signal acquisition module to receive, analyze and process vibration signals, and obtain vibration parameters.

5. A multi-dimensional feature acquisition device for acquiring the features of shallow-needle acupuncture techniques according to claim 4, wherein the vibration signal acquisition module includes an acceleration sensor which is connected to the data processing module.

6. The multi-dimensional feature acquisition device for acquiring the features of shallow-needle acupuncture techniques according to claim 5, wherein the acceleration sensor is connected to the data processing module via a USB interface board.

7. The multi-dimensional feature acquisition device for acquiring the features of shallow-needle acupuncture techniques according to claim 5, wherein the acceleration sensor is bonded to one side of the shallow needle.

8. The multi-dimensional feature acquisition device for acquiring the features of shallow-needle acupuncture techniques according to claim 7, wherein the lengthwise direction of the shallow needle is perpendicular to the plane on which the X-axis and Y-axis of the acceleration sensor are located.

9. The multi-dimensional feature acquisition device for acquiring the features of shallow-needle acupuncture techniques according to claim 7, wherein the acceleration sensor is bonded to the shallow needle.

10. The multi-dimensional feature acquisition device for acquiring the features of shallow-needle acupuncture techniques according to claim 4, wherein the data processing module analyzes and processes the vibration signals, generates the original vibration time-domain waveforms of shallow-needle acupuncture techniques, and/or the synthesized vibration time-domain waveforms of simulating shallow-needle acupuncture techniques.
